(19) United States
(12) Patent Application Publication
(10) Pub. No.: US 2012/0013217 A1
(43) Pub. Date: Jan. 19, 2012

(54) MAGNETIC FLUX CARRYING SLEEVE MEMBER FOR AN ELECTRIC MACHINE

(75) Inventor: Michael D. Bradfield, Anderson, IN (US)

(73) Assignee: REMY TECHNOLOGIES, L.L.C., Pendleton, IN (US)

(21) Appl. No.: 12/834,991

(22) Filed: Jul. 13, 2010

(51) Int. Cl. H02K 1/12

(52) U.S. Cl. 310/216.106

(57) ABSTRACT

An electric machine including a housing and a stator arranged within the housing. The stator includes a body having a first end that extends to a second end through an intermediate portion. The intermediate portion includes an inner diametric surface and an outer diametric surface. A sleeve member is arranged on the outer diametric surface of the stator. The sleeve member includes body member having an inner diametric region that extends to an outer diametric region through an intermediate region. The sleeve member defines a flux carrying member having a magnetic flux flow path that passes magnetic flux from the stator to the outer diametric region.

### BACKGROUND OF THE INVENTION

Exemplary embodiments pertain to the art of electric machines and, more particularly, to a magnetic flux carrying sleeve member for an electric machine stator.

Conventional oil cooled electric machines includes a stator having a stainless steel sleeve. The stainless steel sleeve provides structural support to the stator. The stainless steel sleeve typically includes openings that allow coolant, such as oil, to flow onto end winding portions of the stator. The use of stainless steel prevents magnetic flux from passing from stator laminations into the sleeve. That is, the stainless steel sleeve is a non flux carrying member. The magnetic flux generated during operation of the electric machine is concentrated entirely in a yoke portion of the stator and thus is sized accordingly. That is, the yoke portion must be constructed to have a thickness that is adequate to constrain the generated magnetic flux.

### BRIEF DESCRIPTION OF THE INVENTION

Disclosed is an electric machine including a housing and a stator arranged within the housing. The stator includes a body having a first end that extends to a second end through an intermediate portion. The intermediate portion includes an inner diametric surface and an outer diametric surface. A sleeve member is arranged on the outer diametric surface of the stator. The sleeve member includes an inner diametric region that extends to an outer diametric region through an intermediate region. The sleeve member defines a flux carrying member having a magnetic flux flow path that passes magnetic flux from the stator to the outer diametric region.

Also disclosed is a stator that includes a body having a first end that extends to a second end through an intermediate portion. The intermediate portion includes an inner diametric surface and an outer diametric surface. A sleeve member is arranged on the outer diametric surface of the stator. The sleeve member includes a body member having an inner diametric region that extends to an outer diametric region through an intermediate region. The sleeve member defines a flux carrying member having a magnetic flux flow path that passes magnetic flux from the stator to the outer diametric region.

Also disclosed is a method of operating an electric machine. The method includes receiving a magnetic flux into a stator of the electric machine, passing the magnetic flux through the stator; receiving the magnetic flux into a sleeve member extending about the stator, and flowing the magnetic flux through the sleeve member.

### BRIEF DESCRIPTION OF THE DRAWINGS

The following descriptions should not be considered limiting in any way. With reference to the accompanying drawings, like elements are numbered alike:

FIG. 1 is a cross-sectional side view of an electric machine including a stator having a magnetic flux carrying sleeve member in accordance with an exemplary embodiment;

FIG. 2 is an exploded view of the stator and magnetic flux carrying sleeve member of FIG. 1; and

FIG. 3 is a partial cross-sectional view of the stator and magnetic flux carrying sleeve member of FIG. 1.

### DETAILED DESCRIPTION OF THE INVENTION

A detailed description of one or more embodiments of the disclosed apparatus and method are presented herein by way of exemplification and not limitation with reference to the Figures.

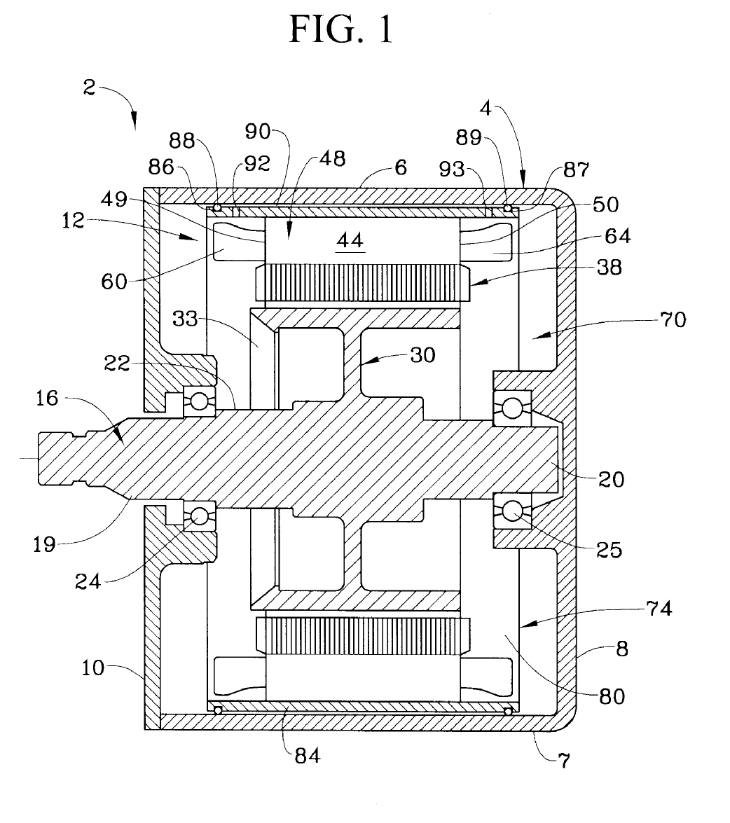

An electric machine in accordance with an exemplary embodiment is indicated generally at 2 in FIG. 1. Electric machine 2 includes a housing 4 having first and second side walls 6 and 7 that are joined by an end wall 8 and a front wall or cover 10 to collectively define an interior portion 12. Electric machine 2 includes a shaft 16 rotatably supported within housing 4. Shaft 16 includes a first end 19 that extends to a second end 20 through an intermediate portion 22. First end 19 is rotatably supported relative to front wall 10 through a first bearing 24 and second end 20 is rotatably supported relative to end wall 8 through a second bearing 25. Shaft 16 supports a rotor 30 that is rotatably mounted within housing 4. Rotor 30 includes a hub 33 that is fixed relative to intermediate portion 22 and a plurality of laminations 38. Plurality of laminations 38 are rotated relative to a stator 44 fixedly mounted to housing 4 to establish an electro-motive force.

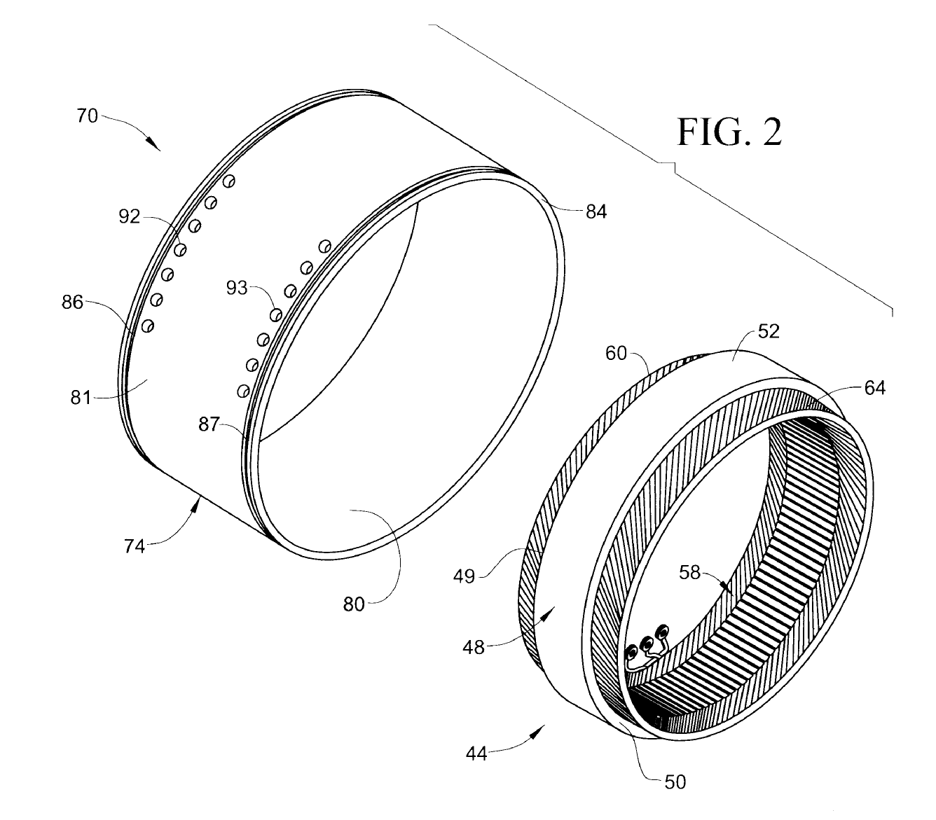

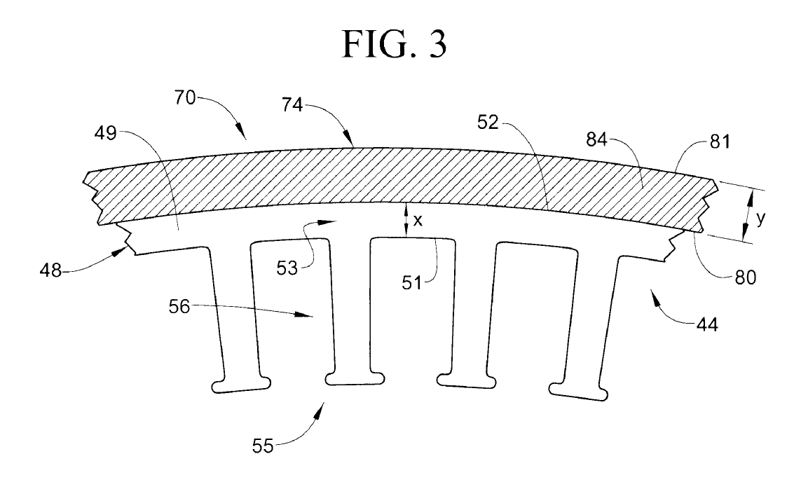

As best shown in FIGS. 2-3, stator 44 includes a body 48 formed from a plurality of laminations (not separately labeled) having a first end portion 49 that extends to a second end portion 50. Body 48 also includes an inner diametric surface 51 that extends to an outer diametric surface 52 through an intermediate or yoke portion 53. Yoke portion 53 includes a thickness X. The particular dimensions for thickness X can vary depending upon the desired design parameters of electric machine 2. Stator 44 is also shown to include a plurality of tooth members, one of which is indicated at 55. Tooth members 55 extend radially inward from inner diametric surface 51 and define a tooth region 56. Body 48 supports a plurality of slot segments or windings 58. Windings 58 include a first end turn portion 60 positioned at first end portion 49 and a second end turn portion 64 positioned at second end portion 50. During operation, a magnetic flux is present at stator 44. The magnetic flux passes through tooth region 56 into yoke portion 53. In conventional electrical machines, the magnetic flux is constrained within the yoke portion. Constraining the magnetic flux within stator requires that the yoke portion be appropriately sized. That is, the yoke portion must have sufficient thickness to carry the magnetic flux without incurring substantial losses. This size requirement establishes a design constraints on the stator. More specifically, the required yoke thickness prevents designers from reducing an overall outer diameter of the stator having a particular design parameter or parameters beyond a prescribed limit without incurring substantial eddy current losses that negatively impact an overall efficiency of the electric machine.

In accordance with an exemplary embodiment, electric machine 2 includes a sleeve member 70 that extends about stator 44. As will be discussed more fully below, sleeve member 70 not only provides structural support to body 48 but also functions as a coolant member that guides coolant onto first and second end turn portions 60 and 64 and I THINK YOU WANT TO KEEP “IS” DON'T YOU? a flux carrying member that receives magnetic flux from outer diametric surface 52. Sleeve member 70 includes a body member 74 having an inner diametric region 80 and an outer diametric region 81 that defines an intermediate region 84 that establishes a magnetic flux flow path (not separately labeled) having a second thickness “Y”. The outer diametric region 81 also includes first and second grooves 86 and 87 that are configured to receive first and second seal members that, in the exemplary embodiment shown, take the form of O-rings 88 and 89 that establish a coolant cavity 90 between body member 48 and an inner surface (not separately labeled of side walls 6 and 7. Intermediate region 84 includes a plurality of openings, two of which are indicated at 92 and 93 that allow a coolant to flow through sleeve member 70 onto end winding portions 60 and 64. As discussed above, sleeve member 70 provides structural support to body 48. Accordingly, sleeve member 70 is configured to be mounted to outer diametric surface 52 of stator 44 with an interference fit. Of course, other mounting arrangements can also be employed.

In further accordance with the exemplary embodiment, sleeve member 70 is formed from a magnetic material such as metal. In accordance with one aspect of the exemplary embodiment, sleeve member 70 is formed from powdered metal (PM). In accordance with another aspect of the exemplary embodiment, sleeve member 70 is formed from PM having particles encased or surrounded by non-magnetic coatings. In a manner similar to that described above, the particular dimension of second thickness “Y” can vary depending upon design parameters for electric machine 2. In accordance with the exemplary embodiment, second thickness “Y” is greater than first thickness “X”. The use of powdered metal enables sleeve member 70 to carry magnetic flux from the stator. Eddy currents generated in the stator are passed from outer diametric surface 52 into inner diametric region 80 and on to intermediate region 84. The particular material employed, and thickness “Y” of sleeve member 70 are configured to ensure that eddy current losses resulting from an increase in reactance are minimized. By providing sleeve member 70 with the ability to carry magnetic flux and also serve as a cooling member, an overall diameter of stator 44 can be reduced from that previously achieved using non-magnetic sleeves. This reduction in size is achieved without incurring a substantial reduction in efficiency, performance and/or output.

At this point it should be understood that the exemplary embodiments provide a sleeve member that not only provides structural support to the stator, but also serves the dual function as a component in the magnetic flux flow path and as a cooling member that delivers coolant flow onto end portions of the stator. Prior art systems employ stainless steel sleeves that have no contribution to magnetic flow. As such, stators are designed to have larger cross-sections that provide a desirable magnetic flow path. In accordance with the exemplary embodiments, radial space that is normally occupied by the stainless steel sleeve becomes integrated into the electromagnetic design. In this manner, the electric machine is formed having a smaller diameter without significantly sacrificing power output.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims.

1-6. (canceled)

7. The electric machine according to claim 23, wherein the sleeve member includes first and second seal members provided on the outer diametric region of the body member.

8. The electric machine according to claim 7, wherein the sleeve member includes a plurality of openings extending through the body member.

9. The electric machine according to claim 8, wherein the openings extend between the first and second seal members.

10. A stator comprising:
a one piece annular body having a first end that extends to a second end through an intermediate portion having an inner diametric surface and an outer diametric surface; and
a sleeve member arranged on the outer diametric surface of the stator, the sleeve member being formed from powdered metal including particles encased in an insulating material and including an inner diametric region that extends to an outer diametric region through an intermediate region, the sleeve member defining a flux carrying member having a magnetic flux flow path that passes magnetic flux from the stator to the outer diametric region.

11. The stator according to claim 10, wherein the intermediate portion of the stator includes a first thickness and the intermediate region of the sleeve member has a second thickness, the second thickness being greater than the first thickness.

12. (canceled)

13. (canceled)

14. The stator according to claim 10, wherein the insulating material comprises a non-magnetic coating.

15. The electric machine according to claim 10, further comprising: a coolant cavity defined between the housing and the sleeve member.

16. The electric machine according to claim 15, wherein the sleeve member includes first and second seal members provided on the outer diametric region of the body member.

17. The electric machine according to claim 16, wherein the sleeve member includes a plurality of openings extending through the body member.

18. The electric machine according to claim 17, wherein the openings extends between the first and second seal members.

19. A method of operating an electric machine, the method comprising:
receiving a magnetic flux into a stator of the electric machine, the stator having a one-piece annular body;
passing the magnetic flux through the stator
receiving the magnetic flux into a sleeve member formed from powdered metal including particles encased in an insulating material extending about the stator; and
flowing the magnetic flux through the sleeve member.

20. The method of claim 19, further comprising: passing coolant through the sleeve member onto the stator.

21. An electric machine comprising:
a housing;
a stator arranged within the housing, the stator including a body having a first end that extends to a second end through an intermediate portion having an inner diametric surface and an outer diametric surface; and
a sleeve member arranged on the outer diametric surface of the stator, the sleeve member including a body member formed from powdered metal including particles encased in an insulating material, the body member having an inner diametric region that extends to an outer diametric region through an intermediate region, the sleeve member defining a flux carrying member having a magnetic flux flow path that passes magnetic flux from the stator to the outer diametric region.

22. The electric machine according to claim 21, wherein the insulating material comprises a non-magnetic coating.

23. The electric machine according to claim 21, further comprising: a coolant cavity defined between the housing and the sleeve member.

24. The electric machine according to claim 21, wherein the intermediate portion of the stator includes a first thickness and the intermediate region of the sleeve member has a second thickness, the second thickness being greater than the first thickness.
